(19) United States
(12) Patent Application Publication
(10) Pub. No.: US 2006/0218108 A1
(43) Pub. Date: Sep. 28, 2006

(54) System for soft computing simulation

(76) Inventors: Sergey Panfilov, Crema (IT); Sergei Ulyanov, Crema (IT)

Correspondence Address: KNOBBE MARTENS OLSON & BEAR LLP, 2040 MAIN STREET, FOURTEENTH FLOOR, IRVINE, CA, 92614, US

(21) Appl. No.: 11/243,511

(22) Filed: Oct. 4, 2005

Related U.S. Application Data
(60) Provisional application No. 60/664,898, filed on Mar. 24, 2005.

(51) Int. Cl. G06N 3/12

(52) U.S. Cl. 706/13

(57) ABSTRACT

The present invention involves a Soft Computing Optimizer (SCOptimizer) for designing a Knowledge Base (KB) to be used in a control system for controlling a plant. The SC Optimizer provides Fuzzy Inference System (FIS) structure selection, FIS structure optimization method selection, and training signal selection and generation. The user selects a fuzzy model, including one or more of: the number of input and/or output variables; the type of fuzzy inference model (e.g., Mamdani, Sugeno, etc.); and the preliminary type of membership functions. A Genetic Algorithm (GA) is used to optimize linguistic variable parameters and the input-output training patterns. A GA is also used to optimize the rule base, using the fuzzy model, optimal linguistic variable parameters, and a teaching signal.

### REFERENCE TO RELATED APPLICATIONS

This application claims the benefit of U.S. Provisional Application No. 60/664,898, filed Mar. 24, 2005, titled “SYSTEM FOR SOFT COMPUTING SIMULATION,” the entire contents of which is hereby incorporated by reference.

### BACKGROUND

1. Field of invention

The invention relates generally to control systems, and more particularly to the design method of intelligent control system structures based on soft computing optimization.

2. Description of the Related Art

Feedback control systems are widely used to maintain the output of a dynamic system at a desired value in spite of external disturbances that would displace it from the desired value. For example, a household space-heating furnace, controlled by a thermostat, is an example of a feedback control system. The thermostat continuously measures the air temperature inside the house, and when the temperature falls below a desired minimum temperature the thermostat turns the furnace on. When the interior temperature reaches the desired minimum temperature, the thermostat turns the furnace off. The thermostat-furnace system maintains the household temperature at a substantially constant value in spite of external disturbances such as a drop in the outside temperature. Similar types of feedback controls are used in many applications.

A central component in a feedback control system is a controlled object, a machine or a process that can be defined as a “plant”, whose output variable is to be controlled. In the above example, the “plant” is the house, the output variable is the interior air temperature in the house and the disturbance is the flow of heat (dispersion) through the walls of the house. The plant is controlled by a control system. In the above example, the control system is the thermostat in combination with the furnace. The thermostat-furnace system uses simple on-off feedback control system to maintain the temperature of the house. In many control environments, such as motor shaft position or motor speed control systems, simple on-off feedback control is insufficient. More advanced control systems rely on combinations of proportional feedback control, integral feedback control, and derivative feedback control. A feedback control based on a sum of proportional, plus integral, plus derivative feedbacks, is often referred as a P(I)D control.

A P(I)D control system is a linear control system that is based on a dynamic model of the plant. In classical control systems, a linear dynamic model is obtained in the form of dynamic equations, usually ordinary differential equations. The plant is assumed to be relatively linear, time invariant, and stable. However, many real-world plants are time varying, highly non-linear, and unstable. For example, the dynamic model may contain parameters (e.g., masses, inductance, aerodynamics coefficients, etc.), which are either only approximately known or depend on a changing environment. If the parameter variation is small and the dynamic model is stable, then the P(I)D controller may be satisfactory. However, if the parameter variation is large or if the dynamic model is unstable, then it is common to add Adaptive or Intelligent (AI) control functions to the P(I)D control system.

AI control systems use an optimizer, typically a non-linear optimizer, to program the operation of the P(I)D controller and thereby, improve the overall operation of the control system.

Classical advanced control theory is based on the assumption that all controlled “plants” can be approximated as linear systems near equilibrium points. Unfortunately, this assumption is rarely true in the real world. Most plants are highly nonlinear, and often do not have simple control algorithms. In order to meet these needs for a nonlinear control, systems have been developed that use Soft Computing (SC) concepts such Fuzzy Neural Networks (FNN), Fuzzy Controllers (FC), and the like. By these techniques, the control system evolves (changes) in time to adapt itself to changes that may occur in the controlled “plant” and/or in the operating environment.

Control systems based on SC typically use a Knowledge Base (KB) to contain the knowledge of the FC system. The KB typically has many rules that describe how the FC determines control parameters during operation. Thus, the performance of an SC controller depends on the quality of the KB and the knowledge represented by the KB. Increasing the number of rules in the KB generally increases (very often with redundancy) the knowledge represented by the KB but at a cost of more storage and more computational complexity. Thus, design of a SC system typically involves tradeoffs regarding the size of the KB, the number of rules, the types of rules, etc. Unfortunately, the prior art methods for selecting KB parameters such as the number and types of rules are based on ad hoc procedures using intuition and trial-and-error approaches.

### SUMMARY

The present invention solves these and other problems by providing an SCOptimizer for designing a KB to be used in a SC system such as a SC control system. In one embodiment, the SCOptimizer displays input values, output values, and member functions (MFs) to allow a user to create a rules database. In one embodiment, the SCOptimizer provides structure selection, structure optimization method selection, and teaching signal optimization. In one embodiment, the user can manually edit the member functions during the optimization process.

In one embodiment, the user makes the selection of fuzzy model, including one or more of: the number of input and/or output variables; the type of fuzzy inference model (e.g., Mamdani, Sugeno, Tsukamoto, etc.); and the preliminary type of membership functions.

In one embodiment, a Genetic Algorithm (GA) is used to optimize linguistic variable parameters and the input-output training patterns. In one embodiment, a GA is used to optimize the rule base, using the fuzzy model, optimal linguistic variable parameters, and a teaching signal.

One embodiment includes fine tuning of the FNN. The GA produces a near-optimal FNN. In one embodiment, the near-optimal FNN can be improved using classical derivative-based optimization procedures.

One embodiment includes optimization of the FIS structure by using a GA with a fitness function based on a response of the actual plant model.

One embodiment includes optimization of the FIS structure by a GA with a fitness function based on a response of the actual plant. The plant can be linear, nonlinear, unstable, etc.

The result is a specification of an FIS structure that specifies parameters of the optimal FC according to desired requirements.

### BRIEF DESCRIPTION OF THE FIGURES

FIG. 1 is a flowchart of the SC optimizer.

FIG. 2 shows the SCOptimizer program window.

FIG. 3 shows the Number Format dialog box.

FIG. 4 shows the Variables page.

FIG. 5 shows the Rule database page.

FIG. 6 shows the Add/Edit Rule dialog for the Mamdani model.

FIG. 7 shows the Add/Edit Rule dialog for the Sugeno 0 model.

FIG. 8 shows the Simulation preview page.

FIG. 9 shows the dialog for creating membership functions for uniform the distribution algorithm.

FIG. 10 shows the Matlab interface parameters page.

FIG. 11 shows the class hierarchy of the SCOptimzer.

FIG. 12 shows the objects used during the fuzzy inference procedure.

FIG. 13 shows the plugin loading and registration process.

FIG. 14 shows the plugin calling process.

### DETAILED DESCRIPTION

The Soft Computing Optimizer (SCOptimizer) provides a system for generating a fuzzy model as described in U.S. application Ser. No. 10/897,978, the entire contents of which is hereby incorporated by reference.

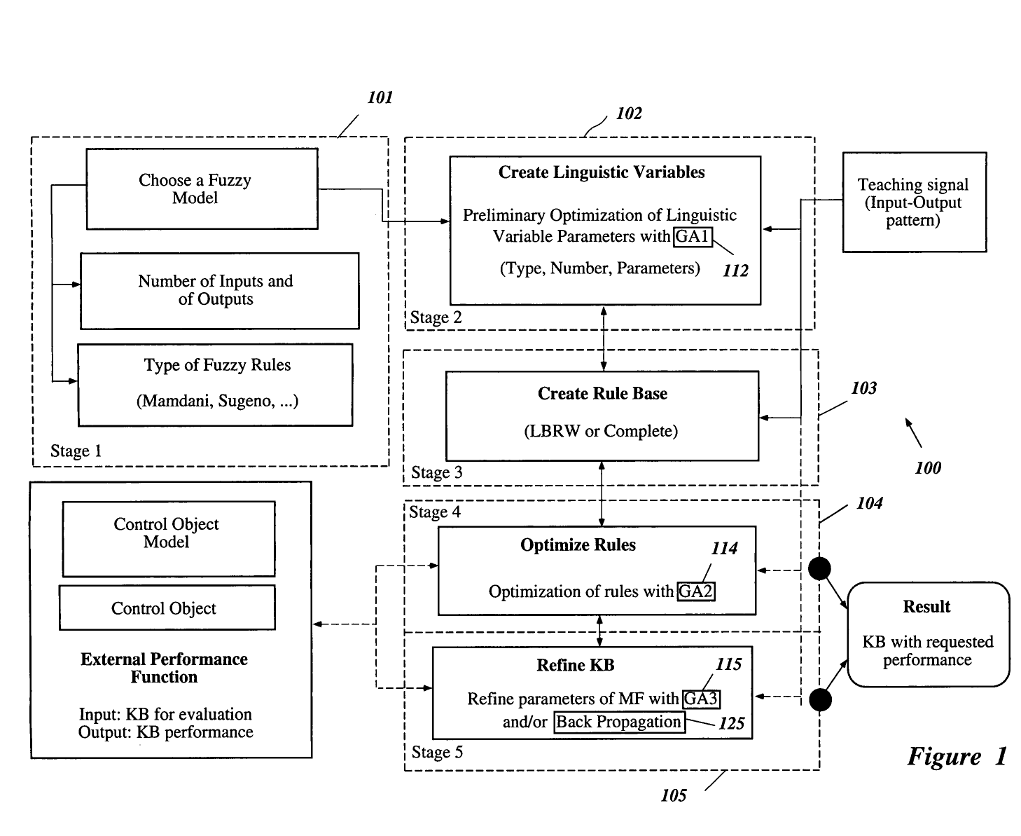

FIG. 1 is a high-level flowchart for the SCOptimizer 100. By way of explanation, and not by way of limitation, the operation of the flowchart divides operation into five stages, shown as Stages 1, 2, 3, 4, and 5 (101-105).

In Stage 1 (101), the user selects a fuzzy model by selecting one or more parameters such as, for example, the number of input and output variables, the type of fuzzy inference model (Mamdani, Sugeno, Tsukamoto, etc.), and the source of the teaching signal.

In Stage 2 (102), a first GA, GA-1 112 optimizes linguistic variable parameters, using the information obtained in Stage 1 (101) about the general system configuration, and the input-output training patterns obtained from the training signal as an input-output table.

In Stage 3 (103), the precedent part of the rule base is created and rules are ranked according to their firing strength. In one embodiment, rules with relatively high firing strength are kept, whereas weak rules with relatively small firing strength are eliminated.

In Stage 4 (104), a second GA, GA-2 114, optimizes a rule base, using the fuzzy model obtained in Stage 1 (101), optimal linguistic variable parameters obtained in Stage 2 (102), the selected set of rules obtained in Stage 3 (103), and the training signal.

In Stage 5 (105), the structure of FNN is further optimized. In order to reach the optimal structure, the classical derivative-based optimization procedures can be used, with a combination of initial conditions for back propagation, obtained from previous optimization stages. The result of Stage 5 (105) is an improved fuzzy inference structure corresponding to the training signal and the plant that was used to generate the training signal. Stage 5 (105) is optional and can be bypassed. If Stage 5 (105) is bypassed, then the FIS structure obtained with the GAs of Stages 2 and 4 is used.

In one embodiment, Stage 5 (105) can be realized as a GA-3 which further optimizes the structure of the linguistic variables, using the set of rules obtained in the Stage 3 (103) and Stage 4 (104). In this case, the parameters of the membership functions are modified in order to reduce approximation error.

In one embodiment of Stage 4 (104) and Stage 5 (105), selected components of the KB are optimized. In one embodiment, if KB has more than one output signals, the consequent part of the rules may be optimized independently for each output in Stage 4 (104). In one embodiment, if KB has more than one input, membership functions of selected inputs are optimized in Stage 5 (105).

In one embodiment of Stage 4 (104) and Stage 5 (105), the actual plant response of the fitness function can be used as a performance criteria of the FIS structure during GA optimization.

In one embodiment, the SCOptimizer uses a GA approach to solve optimization problems related with choosing the number of membership functions, the types and parameters of the membership functions, optimization of fuzzy rules and refinement of the KB.

GA optimizers are often computationally expensive because each chromosome created during genetic operations is evaluated according to a fitness function. For example, a GA with a population size of 100 chromosomes evolved 100 generations, may require up to 10000 calculations of the fitness function. Usually this number is smaller, since it is possible to keep track of chromosomes and avoid re-evaluation. Nevertheless, the total number of calculations is typically much greater than the number of evaluations required by some sophisticated classical optimization algorithms. This computational complexity is a payback for the robustness obtained when a GA is used. The large number of evaluations acts as a practical constraint on applications using a GA. This practical constraint on the GA makes it worthwhile to develop simpler fitness functions by dividing the extraction of the KB of the FIS into several simpler tasks, such as: define the number and shape of membership functions; select optimal rules; fix optimal rules structure; and refine the KB structure. Each of these tasks is discussed in more detail below. In some sense the SCOptimizer 100 uses a divide-and-conquer type of algorithm applied to the KB optimization problem.

In one embodiment, the SCOptimizer 100 uses samples of Input-Output vectors to create and optimize a model of a fuzzy system. In one embodiment, the SCOptimizer 100 design flow includes:
Project creation
Shape definition of the Member Functions (MF)
Creation of a rule database
Optimization of the rule database
Fine tuning of the model (e.g., refinement of the model)

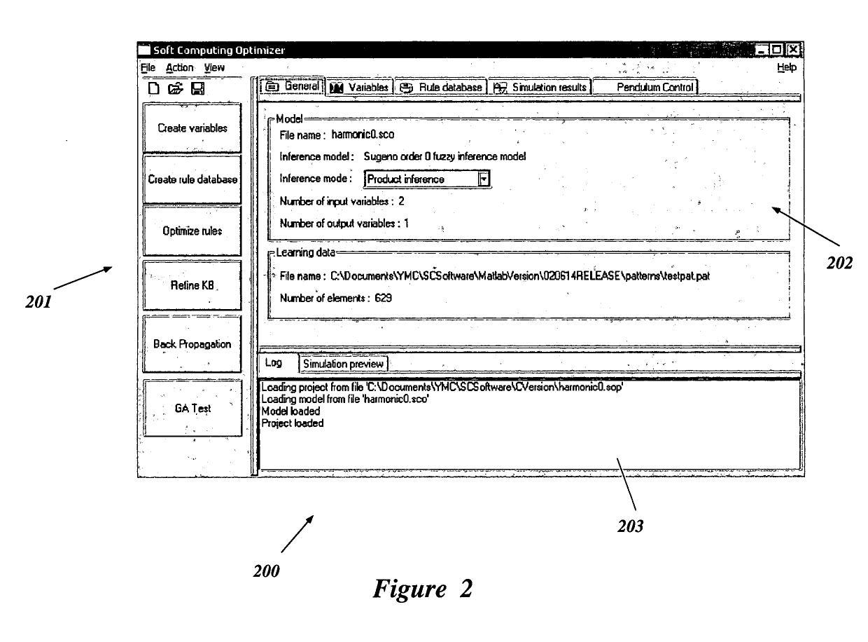

When a new model is created, the user can input various model parameters, such as, for example, model parameters, inference model, number of input and output variables, number of fuzzy sets for each variable, etc. After the model is created (or an existing model is loaded) the user is presented with a main program window 200 shown in FIG. 2. The program window 200 provides Graphics User Interface (GUI) controls to allow the user to view model parameters, start different optimization algorithms, edit the model, etc.

Model optimization includes defining the shape of the membership functions of the fuzzy sets of input and (if used by the model) of output variables. In one embodiment, the SCOptimizer 100 supports two modes of MF shape definition: using the uniform distribution method or by using the first genetic algorithm GA-1 112.

The uniform distribution method distributes fuzzy sets on a signal change interval according to signal probability distribution and a user-selected shape of the membership functions.

The GA-1 112 algorithm attempts to find the best combination of: the number of fuzzy sets per variable, the membership function shape and the overlap coefficient between neighbor fuzzy sets. For each combination, it performs a uniform distribution algorithm and attempts to maximize the mutual possibility of the fuzzy sets of each variable.

Rule database creation includes creating a database that describes which output can be activated for given input. In one embodiment, the SCOptimizer 100 supports two types of rule databases, namely, a complete database and/or an LBRW database.

In the complete database, the rules of the complete database present all possible combinations of fuzzy sets of the input variables. The number of rules in the complete database is equal to the product of the number of fuzzy sets of the input variables. This results in a relatively large database and, consequently, relatively slow optimization speed when used with more than one or two variables.

The LBRW database stores a subset of the rules, namely, the subset of rules selected with a so-called “Let the Best Rule Win” (LBRW) algorithm. The LBRW algorithm selects those rules that contribute relatively more to the output. Reducing the number of rules with the LBRW algorithm provides a faster optimization speed with little or no loss of model precision.

During the rule database optimization, the database is filled with the actual rule data. In one embodiment, the SCOptimizer 100 uses the second genetic optimization algorithm GA-2 114 to optimize the data in the rule database.

The quality of the model created during previous steps is often improved by using a third genetic algorithm GA-3 115. The GA-3 115 is used to alter the shapes of the membership functions and to optimize model output with a fixed number of membership functions and the database structure. In one embodiment, an error back propagation algorithm is also used to improve the model output by fine-tuning database parameters using classical gradient optimization method.

The SCOptimizer 100 optimizes the membership functions according to a training signal. The training signal presents samples of input values and corresponding output values. In one embodiment, the SCOptimizer 100 reads training signal data from Matlab files and/or from text files.

In one embodiment, the training signal text files are processed based on locale data, which defines symbols for decimal point, thousands separators and so on. In one embodiment, the SCOptimizer 100 uses windows settings for these parameters. If those settings do not match signal file format they can be changed by the user. Once changed, locale parameters are saved in model and are used for future processing of data. Locale setting affects reading and writing of text data files and model files.

In one embodiment, the SCOptimizer 100 is configured as an application that runs on a Graphical User Interface (GUI) system, such as, for example, Microsoft Windows.

As shown in FIG. 2, a SCOptimizer window 200 is divided into three parts. On the left-hand part of the window there are command buttons 201, which activate the design steps. Initially some of the buttons 201 are disabled, because actions performed by those buttons cannot be performed before other commands are performed. The inactive buttons are activated after completing previous steps.

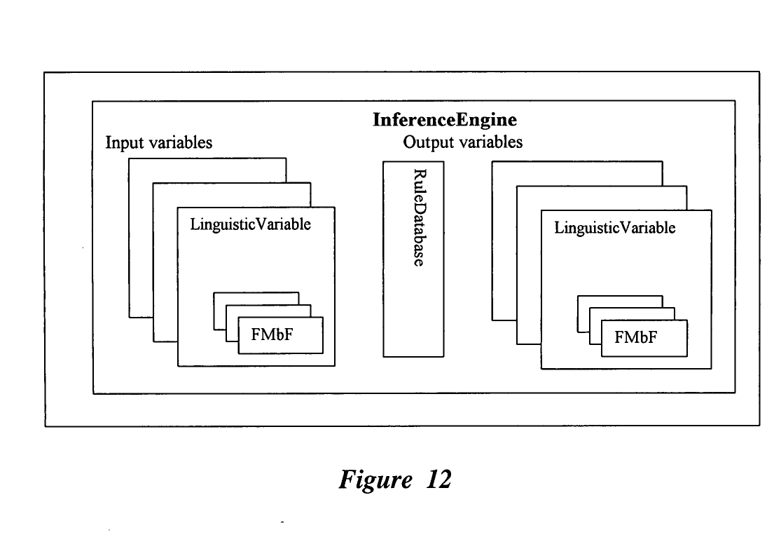

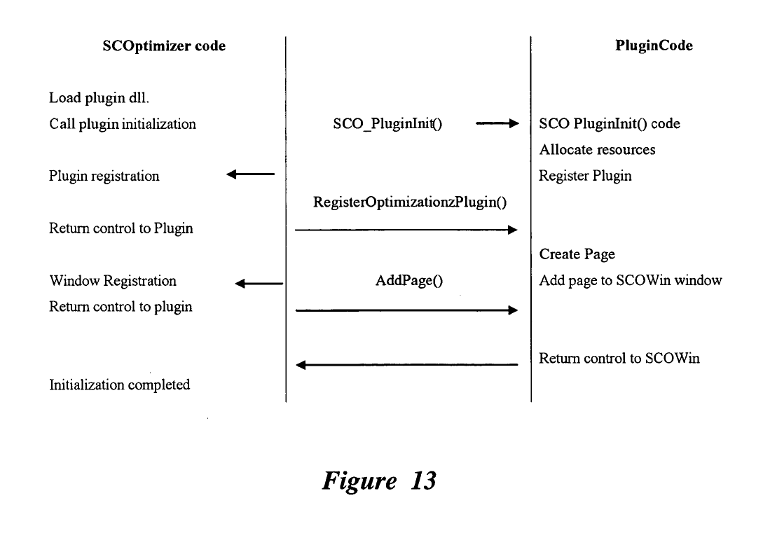

The right-hand portion of the command window shows the model parameters. It is organized as pages 202, each of which displays different properties of the model. The user can switch between the pages 202 using tabs. A “General” page displays main model parameters including file names, inference model, etc. A “Variables” page displays input and output variables and their membership functions. The user can use the variables page to manually edit membership functions. A “Rule database” page shows the state of the model rule database. A “Simulation results” page shows results of the fuzzy inference for the output variables. Other pages, such as, for example, a “Pendulum” page shown in FIG. 2 are provided for visualization of the graphical interface of user-defined plugins provided to the SCOptimizer 100 in order to provide access to various control objects. Plugins are described in connection with FIGS. 12 and 13.

A lower portion of the window 200 is configured as a window 203. The window 203 provides tabs for a “Log” page and a “Simulation Preview” page. The Log page displays a model creation log. The SCOptimizer 100 prints messages during model creation in the window 203. The Simulation Preview page displays training signal and model output. Graphs on the Simulation Preview page are updated as the model parameters are changed.

A window menu is provided to the page 200. The window menu includes top-level menus labeled File, Action, and View.

The File menu includes the following drop-down menu items:
New: Closes the current model and starts creation of a new model.
Open: Opens an existing model from a file.
Load Teaching Signal: Loads a training signal.
Save: Saves the current model to the file it is loaded from.
Save As: Saves the current model to another file.
Number Format: Set number format conventions for the training signal.
Exit: Closes The SCOptimizer 100.

The Action menu includes the following drop-down menu items (which correspond to the command buttons 201):
Generate Variables: Create variables using the uniform distribution and/or the GA-1 112 algorithms.
Create Rule Database: Create the rule database (103).
Optimize Rule Database: Optimize rule database (104) using the GA-2 114 algorithm.
Refine KB: Refine the model using the GA-3 115 algorithm.
Back propagation: Optimize the rule database using the back propagation algorithm 125.
GA Test: Run an abstract genetic optimization.

The View menu can be used to switch between the SCOptimizer 100 pages and includes the following drop-down menu items:
Project properties: Display the General properties page.
Variables: Display the Variables page.
Rule Database: Display the Rule Database page.
Log: Display the Log page.
Simulation Preview: Display the Simulation Preview page.

In one embodiment, a model file is used to store model data, such as, for example, the model type, variables, membership functions, the rule database, etc. In one embodiment, a project file is used to store information about files used in the project, including the file names of the model file and the training signal file.

The user creates a new model by selecting File/New from the menu. Selecting File/New displays a multi-page wizard-style create-model dialog box that guides the user through a series of dialogs to create the new model. The first page of the create-model dialog allows the user to enter the following data:
Model file name: The name of the model.
Inference model: In one embodiment, the SCOptimizer 100 supports the Mamdani model and Sugeno order 0 and 1 models. One of ordinary skill in the art will recognize that other models can be provided.
Inference mode: The inference mode corresponds to the type of operation for fuzzy AND. In one embodiment, the inference mode can be product or minimum.

A second page of the create-model dialog allows the user to select the number of input and output variables.

A third and fourth page of the create-model dialog allows the user to specify the properties of the input and output variables. Each page provides a list with suggested variable names and the number of membership functions. The user can select items from the lists to change parameters.

A final page of the create-model dialog allows the user to specify a training signal file. Messages describing creation of the new model are displayed on the Log page.

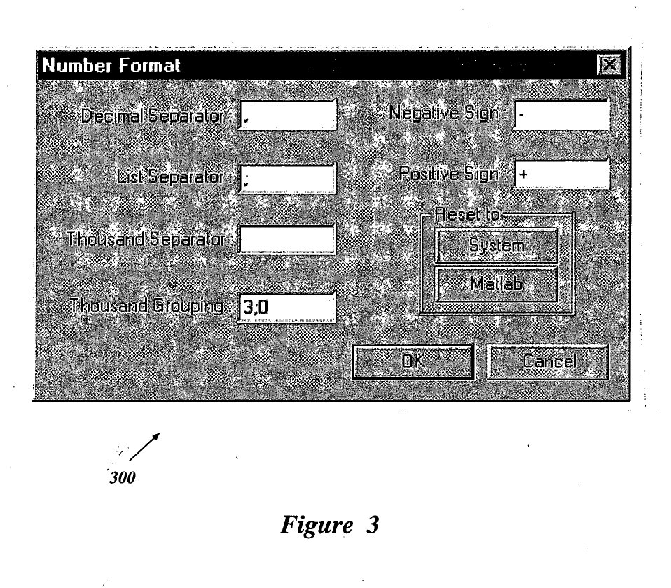

In one embodiment, the training signal file can be in Matlab format or in text file format. Text files are processed using locale settings. FIG. 3 shows a dialog box 300 for specifying the locale parameters. The dialog box 300 includes controls to allow the user to specify a list separator, a decimal separator, a negative sign, a positive sign, a grouping method, and a thousands separator. The list separator is a symbol or string used to separate several successive numbers in list. The decimal separator is a character used to separate integer and fractional portions of a real number. The negative sign is a character used to indicate a negative number. The positive sign is a character used to indicate a positive number.

The grouping method is used to define how digits of the integer part of a real number are grouped. This is a semicolon-separated list of numbers, defining the number of digits in each group, from right to left. A trailing 0 means “use previous value for all following groups”. In one embodiment, the SCOptimizer 100 inserts the thousands separator in every place defined by the grouping method, but will accept thousand separators in any position in input files.

The thousands separator defines the character used to separate groups of digits, defined by the grouping method.

For example, Matlab text files correspond to the following settings
List separator: ‘;’
Decimal separator: ‘.’
Negative sign: ‘−’
Positive sign: ‘+’
Grouping method: ‘3;’
Thousand's separator: ‘ ’

The first page with model parameters the user sees is the General page. It contains project information including:
The name of the file containing the model.
The inference model.
The inference mode (operation used as fuzzy OR).
The number of input and output variables.
The name of the file containing the training signal.
The number of teaching signal samples in the training signal file.

The inference mode can be changed by selecting the minimum or product inference mode from the drop-down list.

To get detailed information about model variables and rule database switch to corresponding pages, described in the following sections.

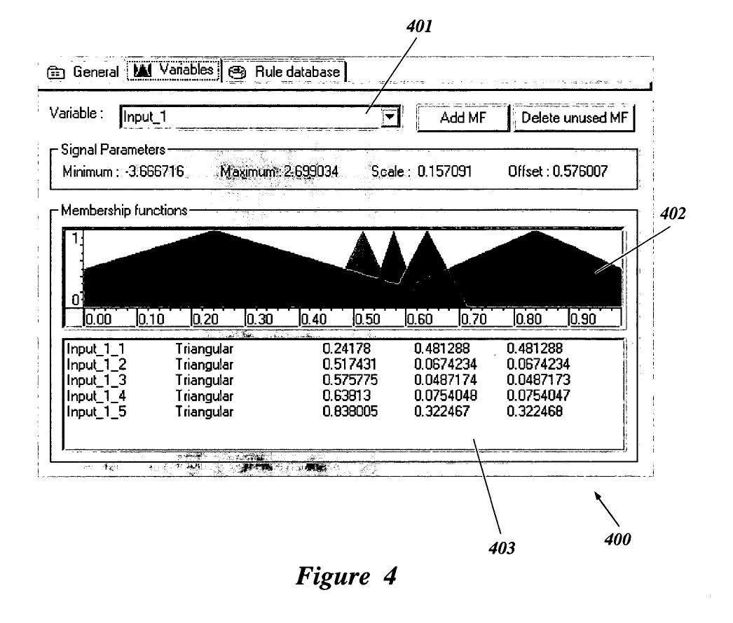

Model variables can be viewed and edited on the Variables page 400 shown in FIG. 4. The user can switch to this page by clicking on the Variables tab or by selecting View/Variables menu command. The user can select a desired variable (e.g., Input_{—}1, etc.) by selecting a variable name from a drop-down list 401.

For the selected variable, the parameters: Minimum, Maximum, Scale, and Offset are listed. The minimum and maximum parameters are the margins of the signal change interval. The SCOptimizer 100 uses a normalized signal for internal calculations. The normalization parameters are Scale and Offset. The following formula is used for normalization:
normalized_value=input_value*Scale+Offset.

Variables page 400 also includes a graph 402 showing the membership functions (MFs) of the variable. The graph 402 displays distribution functions of the MFs. The user can change the appearance of this window by using a pop-up menu, activated by a right-click of the mouse. The pop-up menu provides the following menu commands:
Denormalized Space
Normalized Space
Track Cursor
Display MF Supports
Display Signal Interval
Color Shapes
Color Lines
B&W Lines
Save Image

The Denormalized space command draws the x-axis coordinates using denormalized (signal) space. The Normalized space command draws the x-axis coordinates using normalized (internal for the SCOptimizer 100) space. The Track cursor command displays the margins of alpha-levels. When the mouse cursor is on the y-axis then lines representing alpha level are drawn, as well as color lines which show margins of this level for MFs. When the cursor is somewhere else on the window, then vertical lines at the position of the cursor and horizontal lines from intersections of this line with the MFs are drawn. The Display MF supports command display supports of the MFs using colored vertical lines. The Display signal interval command displays margins of the signal change interval with vertical lines. The Color shapes command draws functions using filled color figures (default). The Color lines command draws functions using colored lines. The B&W lines command draws functions using black lines. The Save Image command saves the current image to a file.

The user can use the window 402 to change MF distribution parameters by moving the mouse to the x coordinate of the modal value or support margin of one of the MFs. A Colored line appears showing the selected parameter. The user can then press and hold the left mouse button and move the mouse left or right to change the parameter. The new shape of the MF is drawn using an outline method. The user can then release the left mouse button when the desired shape of the MF is achieved.

A list 403 of the page 400 lists the membership functions and their parameters. Each line of the list 403 contains the MF name, the distribution type, and the distribution parameters. The user can change the parameters by double-clicking a list item, which causes a dialog box to appear. This dialog box displays parameters of the membership function. Parameters can be changed by entering new data into corresponding fields. The user can also use this dialog to delete membership functions of input variables. If the rule database is already created, then rules with if-part using this membership function will also be deleted. An “Add MF” button allows the user to manually add new membership function to the current variable.

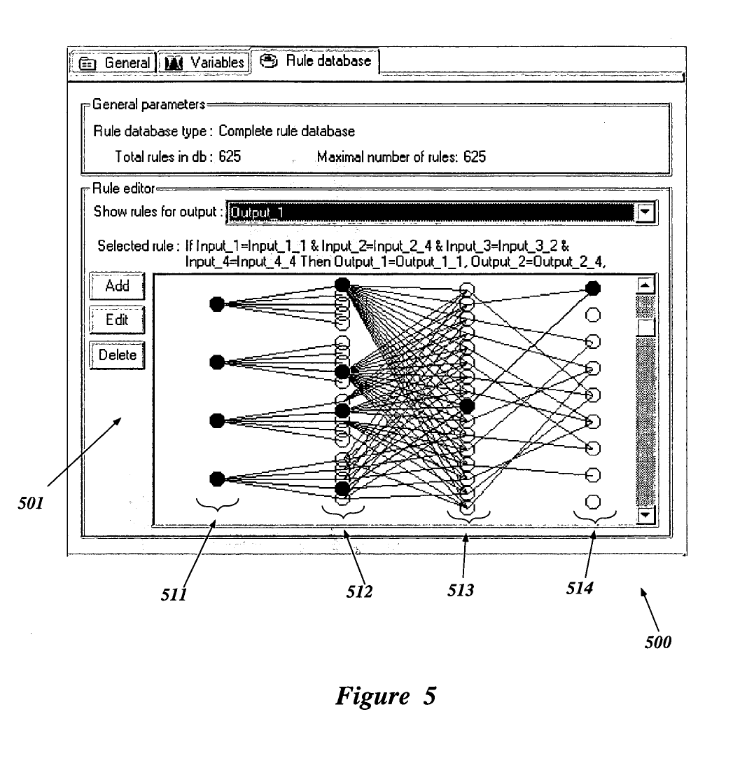

To view or edit the rule database the user can switch to the rule database page 500 shown in FIG. 5. The rule database page 500 displays the following parameters:
Rule database type: The type of the database used in the model (e.g., complete rule database or LBRW Rule database).
Maximal number of rules: The maximal number of rules for the current model.
Total rules: The total number of rules stored in the database (for a complete database this is equal to maximal number of rules, for a LBRW database it can be less than maximal).
Show rules for output: The rule database is displayed for one of the outputs. This list selects output variable for which database are displayed.
Selected rule: Displays a textual representation of selected rule, if any.

A rule database editor 501 displays the database as a network with four layers. The first layer 511 is the input variable layer. Each circle in the first layer 511 represents an input variable. The second layer 512 is the input MF layer. Circles of the second layer 512 represent membership functions of variables. Circles in the third layer 513 represent rules of the database. The fourth layer 514 is the output layer. For a Mamdani model output, the fourth layer 514 is composed of circles, corresponding to membership functions of the selected output variable. For the Sugeno models, the fourth layer 514 displays numerical parameters of the rule.

The database structure is shown with lines that connect the nodes in the different layers. Each node in the rule level 513 is linked with those MFs in the input MF layer 512 that are included in the if-part of the rule. It is also linked with the output MF 514 or the numerical parameter of the then-part.

The user can select a rule from the database by clicking on the node of the rule level 513. Lines (connections between layers 511-514) associated with the selected rule are highlighted. A textual representation of the rule is shown in the Selected rule field. The user can edit or delete the selected rule (rules from a complete database can not be deleted).

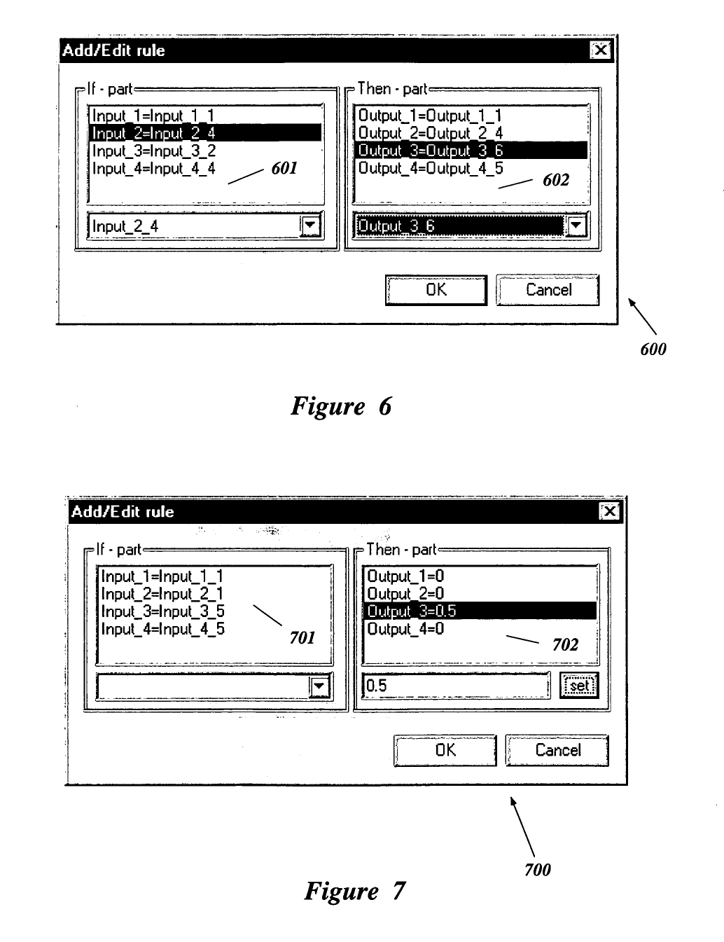

FIG. 6 shows an Add/Edit dialog 600 for the Mamdani model. A left-hand list 601 of the dialog 600 represents the if-part of the rule, and a right-hand list 602 part corresponds to the then-part. The user can change parameters of any part by selecting items from the lists 601, 602 and changing values in the drop-down box below the list.

FIG. 7 shows an Add/Edit dialog 700 for the Sugeno 0 model. To change an output parameter for the Sugeno 0 model the user selects a corresponding line from an output list 702, enters a new value in a text field below the list 702, and press a “set” button.

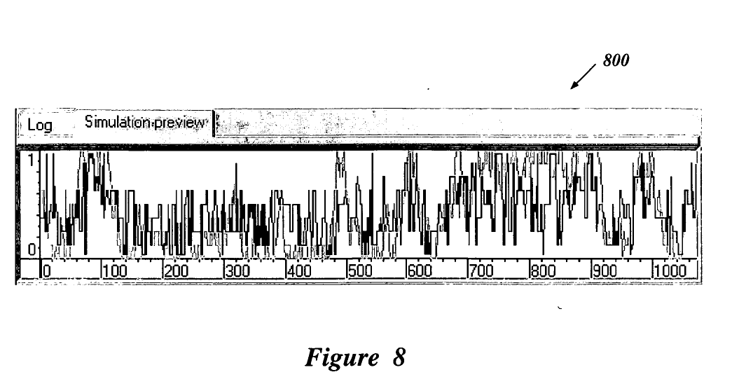

FIG. 8 shows a simulation preview page 800 used to verify the current model output. The simulation preview page 800 can be activated by clicking the mouse on the Simulation preview tab or by selecting View/Simulation preview menu command. The simulation preview page 800 displays both the training signal and the model output for one of the output variables.

Highlighted regions correspond to samples of the training signal that do not have rules with a corresponding if-part in the database. The model cannot calculate output for those samples.

The simulation preview window can be customized by a pop-up menu, activated by click of the right mouse button inside the window, that includes the following menu items:
Variable: Change the output variables signals that are displayed.
Display error interval: Highlight regions for which output is not calculated properly.
Display delta: Display the difference between the training signal and the model output. In this mode a first color line shows the error level and a second color line shows the error value.
Color lines: Display signals using different colors.
B&W lines: Display signals with black lines.
Save Image: Save contents of the window as Windows BMP file.

When creating the model, the user can create membership functions of the variables by pressing the Create Variables button or selecting the Action/Generate Variables to open the create variables wizard.

Using the create variables wizard, the user can select the number of MFs per variable and their shape manually, using a uniform distribution algorithm. Or, the SCOptimizer 100 can optimize the MF parameters using the GA-1 112 algorithm.

When working with the GA-1 112 algorithm, the user can run a signal-filtering algorithm that removes redundant signals according to a desired signal threshold level. This can improve the quality of the fuzzy sets created by the GA-1 112 algorithm.

The user can also instruct the GA-1 112 algorithm to alter the shapes of the MFs, but not their number.

The user can also select the specific variables to be optimized. The default action is to optimize all variables.

While the GA-1 112 algorithm operates, a progress dialog shows the number of the current generation and the achieved level of evaluation function. In one embodiment, the GA-1 112 uses different fitness functions for input and output variables, so it will first optimize input variables and then output variables.

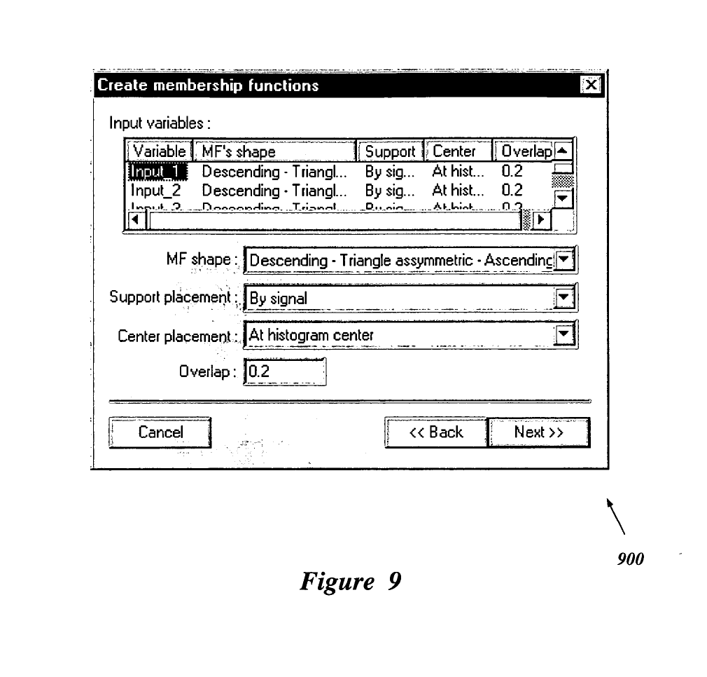

For uniform distribution algorithm, the user can manually select the shapes of membership functions using the dialog 900 shown in FIG. 9. The dialog 900 provides the following controls:
MF Shape: The shapes of the membership functions.
Support placement: Specify how to place supports. By signal means distribute supports so that each one will include equal number of training signal samples. Uniformly will distribute supports uniformly on the signal change interval.
Center placement: Specify how to place centers of non-symmetrical distributions. At histogram center places the center so that there are equal number of signal samples in the support area to the left and to the right from center. Closer to interval bounds will shift the center of the MF to the nearest signal interval bound. The amount of shift increases with distance from the interval center.
Overlap: The overlap coefficient between neighbor supports. Values from −1 to 1 are allowed, 0 meaning no overlap, positive values produce overlapping supports, negative values produce space between supports.

After specifying the input variables, the user can fill parameters for the output variables. Once the input and output variables are specified, the uniform distribution algorithm will create the MFs.

After the user has created the variables and membership functions, the user can create the rule database by pressing the Create rule database command button or by using the Action/Create rule database menu to display the rule database dialog.

The rule database dialog allows the user to select the type of the rule database (e.g., complete database, LBRW database, etc.) The complete rule database stores all the rules for a given model. The number of rules in the complete database is given by the product of the number of fuzzy sets of input variables. This results in a relatively large database and relatively slow optimization speed.

The LBRW database stores only selected rules, which are chosen by LBRW algorithm. When creating the LBRW database, the user can specify the exact number of rules or the minimal level of firing strength (threshold level). In the latter case, the resulting database includes rules with firing strength greater than or equal to the threshold. The user can also use automatic rule number estimation mode to select a minimal number of rules, so that the given number of rules covers each point of learning data, if possible.

The user can also specify how the LBRW algorithm sorts rules. If the user selects “Sum of firing strength” then the LBRW algorithm adds the firing strengths of the rules for each sample of the training signal. If the user selects “Maximum of firing strength” then the maximal value are used.

The database created by using the Create Rule Database command has all outputs set to 0. Entries in the database are created by the optimization procedure. In one embodiment, the SCOptimizer 100 uses the GA-2 114 optimization to optimize the database. The database states are analyzed by comparing inference output with the training signal and minimizing difference between the two. In one embodiment, each output is optimized separately.

To start database optimization, the user selects the Optimize rules command button or the Action/Optimize rule database menu item to open the rule database optimization wizard.

The rule database optimization wizard allows the user to select the training signal source for the GA-2 114 algorithm. The user can select the complete training signal or an optimized teaching signal. If the user selects the optimized training signal, then a pattern reduction algorithm is used to optimize training signal. The pattern reduction algorithm attempts to select only those samples of the complete training signal that activate different rules. Using the optimized training signal increases the speed of the GA-2 114 optimization speed without significant loss in precision. The user can also use Matlab/Simulink simulation as source of data for the GA-2 114 optimization.

The user can also select the output variables for which the database is to be optimized. By default, optimization is selected for all variables. The user can select to have the output variables optimized one after the other or all at the same time.

During optimization, a progress window appears. The progress window shows which variable is currently optimized, the number of the current generation, and the achieved level of the evaluation function.

After the rule database is optimized, the user can further improve the model quality by using the GA-3 algorithm for MF optimization. The user selects start model refinement by clicking the Refine KB command button or by selecting the Action/Refine KB menu item to activate a model refinement wizard. The model refinement wizard allows the user to select optimization based on a maximization of mutual information entropy, a minimization of output error, and/or a Matlab simulation. In the Maximization of mutual information entropy optimization, the SCOptimizer 100 minimizes the mutual information entropy between MF fuzzy sets. This similar to the function used in the GA-1 112 algorithm, but unlike the GA-1 112, the GA-3 115 does not change the number of MFs per variable. Rather, the MF parameters are changed. In the minimization of output error optimization, the output error is minimized by the GA-3 115. In the Matlab simulation optimization, Matlab/Simulink is used to calculate the fitness function.

The model refinement wizard also allows the user to select the input variables to be optimized. By default, optimization is selected for all variables. The variables can be optimized separately or together.

While the GA-3 algorithm operates, a progress dialog shows the number of the current generation and the achieved level of the evaluation function.

If the user is still not satisfied with model quality, the user can run the rule database optimization GA-2 114 again and/or run the error back propagation algorithm 125.

The back propagation algorithm 125 implements a classical gradient-type optimization method, which provides an effective way to further improve the model after genetic optimization. The user can start the back propagation algorithm 125 by clicking the Back Propagation command button or selecting the Action/Back Propagation menu item to display the back propagation wizard.

The back propagation wizard allows the user to specify the back propagation algorithm parameters learn rate and stop criteria. The learn rate defines how much the model parameters can be changed in response to the output error. The stop criteria defines how the back propagation algorithm is stopped. In one embodiment, the algorithm can be can be stopped after a fixed number of iterations or when a change of output error becomes less than a given threshold.

On the second page of the back propagation wizard, the user can select which input variables are to be optimized. By default, the optimization is selected for all variables.

The user can use Matlab/Simulink to calculate the fitness functions for one or more genetic algorithms used during creation of the model. When using Matlab/Simulink the genetic algorithm executes a Matlab function specified by the user to obtain one or more fitness values for the current model state. This function in turn makes calls to the SCOptimizer 100 library functions (e.g., GAInfer/SimGAInfer) that perform the inference operation with current model. Matlab functions compute the fitness function based on the model output and return it to the SCOptimizer 100.

When the user selects Matlab for calculation, a Matlab parameters dialog is displayed to allow the user to specify an initialize session command, a fitness calculation command, and a close session command.

The initialize session command is executed at the beginning of the genetic optimization. A string parameter of the initialize session command is passed to the GAConnect/SimGAConnect function to initialize the session with the SCOptimizer 100.

The fitness calculation command is called each time the fitness value is required. This command can calculate the fitness value using GAInfer/SimGAInfer and place it in a variable called SCO_Fitness.

The close session command is executed when the genetic optimization is finished. The close session command calls GADisconnect/SimGADisconnect to close the Matlab-SCOptimizer 100 link and to free other resources, if any. If the user does not specify close session command then Matlab session will not close when the optimization is over.

When the genetic optimization starts, the SCOptimizer 100 starts the Matlab session and executes the initialize session command, the fitness calculation command, and the close session command as Matlab commands.

A GA test mode can be used to perform optimization of abstract variables using Matlab for fitness value calculations. For example, this mode can be used to generate the training signal for the SCOptimizer 100. The user can start the GA test algorithm by clicking the GA Test command button or by selecting the Action/GA Test menu item to display a GA test wizard.

The first page of the GA test wizard allows the user to enter genetic algorithm parameters.

The second page of the GA test wizard allows the user to define the parameters to be optimized. Parameters are entered in groups. Parameters inside each group have equal characteristics. For each group, the user can enter a number of elements in the group, a minimal value, a maximal value, and a search step. The actual search step can be less than specified, based on a number of bits used to represent a value. A list at the top part of the wizard displays the currently-defined groups of parameters. A line below the list graphically displays parts of the chromosome used to represent each group. Controls are provided to allow the user to add, change and delete groups.

The user can instruct the SCOptimizer 100 to optimize groups together or separately.

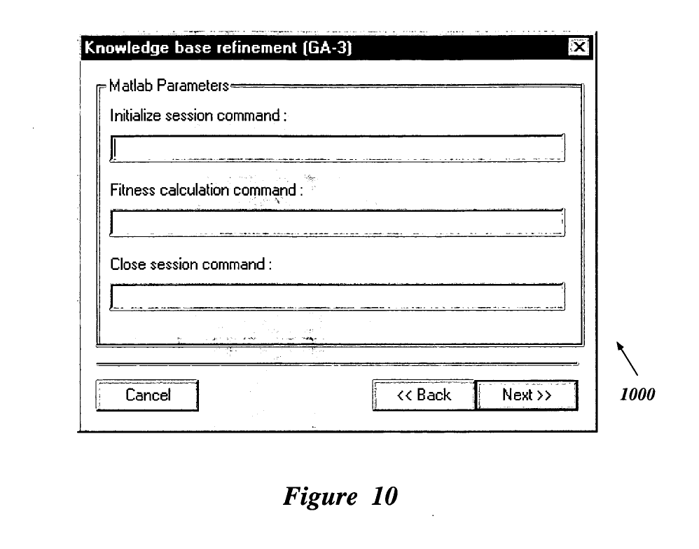

As shown in FIG. 10, a third page of the GA test wizard provides the Matlab commands page 1000. The SCOptimizer 100 adds following text to the fitness calculation command: (N,[x1, . . . ,x1]), where N=0 for when the groups are optimized together; otherwise, N is the index of the group. The values x1, . . . ,x1 correspond to the values of the currently optimized parameters (current group or all groups). Inference is a software tool designed to simulate a fuzzy system behavior in order to verify the approximation level obtained during the learning phase or to use inference process from other applications. Inference can work in two modes: simulation on a single pattern, or simulation from file.

To obtain a fuzzy system output for a single pattern run, Inference is run with the following arguments:
inference.exe model.sco input_{—}1 input_{—}2
   where model.sco is the name of the model file created by the SCOptimizer 100. The input values input_{—}1 and input_{—}2 specify the first and second input variables, respectively. The user can specify input values for all input variables of model. Inference calculates the output variables and provides the output variables to the user.

To simulate a fuzzy system on a large number of input vectors, the user can use simulation from file mode as fllows:
inference.exe model.sco in_file out_file.txt
   Where model.sco is the name of the file with model created by the SCOptimizer 100 and in_file and out_file are the names of the input file and the output file, respectively. The input file can be a Matlab file or a text file.

The user can use models created with the SCOptimizer 100 to perform inference calculations from C++ code, using an SCLib library module.

For simple inference operations the SCLib module defines three functions:

BOOL SCLoad(const TCHAR * name, InferenceEngine **Engine)
FloatVector SCInfer(FloatVector & in, InferenceEngine *Engine)
void SCFree(InferenceEngine **Engine)

The function SCLoad loads the model from a file. The parameter “name” is a pointer to a string containing the SCOptimizer 100 model. SCLoad returns TRUE if the load operation is successful, and FALSE when an error occurs.

The SCInfer function computes the fuzzy inference. The input vector “in” is an input data vector. The function SCInfer returns a vector containing the inference result. In case of error, an empty vector is returned.

The function SCFree frees memory allocated by the function SCLoad.

In one embodiment, the SCLib library includes the following functions to support a Simulink workspace interface for storing the engine pointer:
BOOL SimSCLoad(const TCHAR *name, SimStruct * S);
FloatVector & SimSCInfer(FloatVector &in, SimStruct *S);
void SimSCFree(SimStruct *S);

The functions SimSCLoad, SimSCInfer, and SimSCFree provide the functionality as previously described in connection with SCLoad, SCInfer, and SCFree, respectively, but use a SimStruct to store the engine pointer between calls.

When using Matlab as a source of the training data for the genetic algorithms in the SCOptimizer 100, the user can use the following functions to compute the fuzzy inference:
BOOL GAConnect(LPCTSTR param)
FloatVector & GAInfer(FloatVector &in)
void GADisconnect( )

The function GAConnect is called to establish a connection with the SCOptimizer 100 process. The argument param is a text string passed by the SCOptimizer 100 as a parameter of the initialize session command. This function should be called before the first call to GAInfer( ).

The function GAInfer performs the inference using the current SCOptimizer 100 state.

The function GADisconnect frees resources associated with the SCOptimizer 100 link. The user should call this function once for each call to GAConnect( ). Simulink versions of those functions are also available:

The SCOptimizer 100 supports the following fuzzy membership function shapes: exact numbers, triangular, trapezium, descending, ascending, normal (Gaussian), asymmetrical normal, normal descending, and normal descending.

The MF of exact numbers equals 1 at some value and 0 in all other cases.

The MF of a triangular distribution equal 1 at modal_value and linearly decreases to 0 at modal_value−left_fuzzy and modal_value+right_fuzzy points. The triangular distribution is written in the following form:
tr(modal_value; left_fuzzy;right_fuzzy)

The MF of the trapezium distribution equals 1 on the interval [left_tolerant,right_tolerant] and linearly decreases to 0 at the left_tolerant−left_fuzzy and right_tolerant+right_fuzzy points. The trapezium distribution is written as:
tp(left_tolerant;right_tolerant; left_fuzzy;right_fuzzy).

The MF of the descending distribution equals 1 at all points less than or equal to modal_value, then it linearly decrease to 0 at modal_value+fuzzy point and remains at 0 for greater values. The descending distribution is written as:
ds(modal_value;fuzzy).

The MF of the ascending distribution equals 0 at points less than modal_value-fuzzy, then it linearly increase to reach 1 at modal_value. At points greater than modal_value it equals 1. The Ascending distribution format is:
as(modal_value;fuzzy).

The MF of the normal distribution is changed according to the Gaussian function: exp(−9*α-modal_value)²/(2*fuzzy²). The normal distribution format is:
n(modal_value;fuzzy). Asymmetrical normal

The asymmetrical normal distribution has the shape of Gaussian a function with different scale parameters to the left and to the right. The format for the asymmetrical normal distribution is:
asymn(modal_value;left;right).

The MF of the descending normal distribution equal 1 at all points less than or equal to modal_value. Above modal_value, it has the shape of a Gaussian function. The descending normal distribution format is:
descn(modal_value;fuzzy).

The MF of the ascending normal distribution equals 1 at all points greater than or equal to modal_value. Below modal_value it has the shape of a Gaussian function. The Ascending normal distribution format is:
ascn(modal_value;fuzzy).

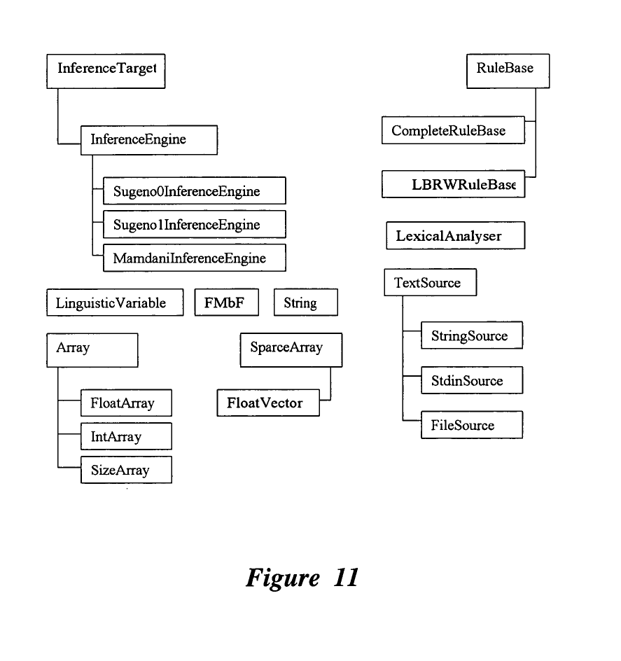

The class structure of one embodiment of the SCOptimizer 100 library is shown in FIG. 11. The primary base classes are InferenceTarget, RuleBase, and LinguisticVariable. The LinguisticVariable class encapsulates arrays of FMbF objects. The FMbF objects include the fuzzy membership functions. FIG. 12 shows the objects used during the fuzzy inference procedures.

Fuzzy inference rules are stored with the help of the RuleBase class and its child classes CompleteRuleBase and LBRWRuleBase. The class CompleteRuleBase encapsulates a complete rule database, and the LBRWRuleBase class encapsulates the LBRW database. RuleBase objects provide storage and access to rule data, they do not deal with the internal structure.

The fuzzy inference algorithm, implemented in the InferenceEngine class, detects rules, which are active for given input and sends their numbers to the InferenceTarget class. The InferenceTarget can be an InferenceEngine or user-supplied class. The InferenceEngine class extracts rules from database and perform required calculations.

The Lexical analyzer, implemented in the LexAnalyser class, is used to read model data, text data files and process user input. It converts a stream of characters to a stream of lexemes, representing words, numbers and different separators. A TextSource class and its child classes represent input stream for the LexAnalyser to allow the LexAnalyser to be used to process files, memory strings and direct user input.

Supplementary classes, representing dynamic arrays, text strings, and others are used by other classes.

In one embodiment, the SCOptimizer 100 provides plugin support to give the user the opportunity to add new types of fitness function calculations, such as, for example, experimental testing on hardware, new mathematical models, etc.

As shown in FIG. 13, the SCOptimizer 100 plugin includes a dynamically-linked library (DLL). The plugin is placed in the same directory where the SCOptimizer 100 module, scowin.exe, is located. When the SCOptimizer 100 starts, it searches its directory for plugin modules and loads them. If a plugin is successfully loaded, then user is able to select it as a source of optimization data in the corresponding dialogs. Plugins also allow the user to add pages to the SCOptimizer 100 window shown in FIG. 2.

During initialization, the SCOptimizer 100 loads the plugin modules and calls their initialization functions. Each plugin registers itself and creates page windows, as required. FIG. 12 illustrates the plugin loading and registration process.

The GA-2 114 and GA-3 optimization starts when the corresponding wizard window is displayed. The wizard searches the list of available plugins, determines which plugins support the current optimization stage, and lists the resulting plugins in the window.

When the user is finished with the wizard, the wizard calls the optimization procedure. If a plugin is selected as an optimization source then the plugin parameters are passed to the optimization procedure.

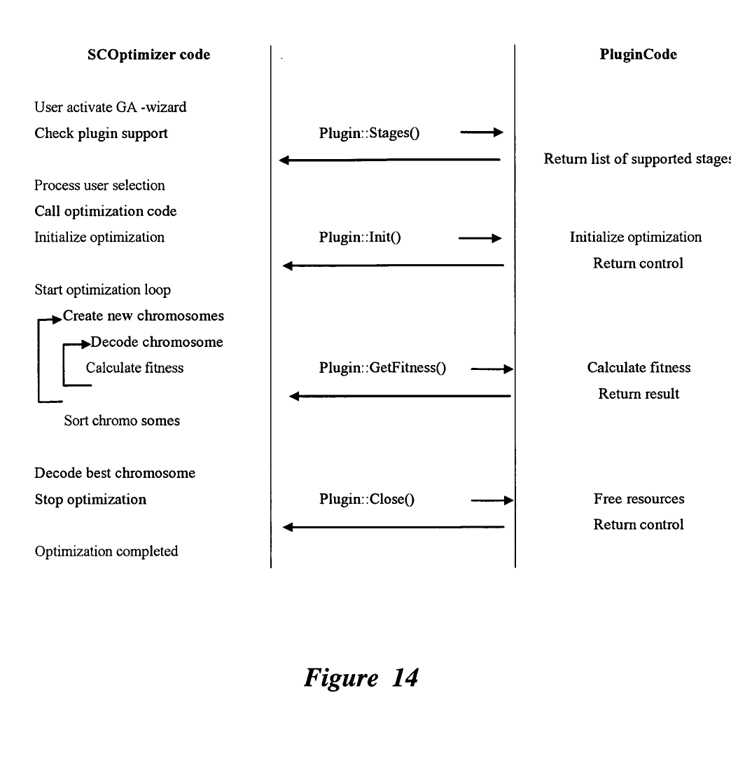

As shown in FIG. 14, the optimization procedure calls a plugin Init ( ) method. If Init( ) returns TRUE, then the optimization procedure proceeds with the optimization. The GA optimization method operates with chromosomes, each of which represents some model state (e.g., in the GA-2 114 the chromosomes represent rule database state, in the GA-3 the chromosomes represent fitness functions of the input variable). When the new variable is generated, the optimization code changes the model state to one encoded in the chromosome and calls GetFitness ( ) to calculate the fitness value for the state. The optimization algorithm tries to maximize the fitness value by operating on the chromosomes. When the optimization is finished, the model state is set according to the chromosome with the maximum fitness value found during optimization. The Close( ) method is called when optimization is complete.

Plugin-dependent parameters can be entered in the plugin page in the SCOptimizer 100 window or if the plugin can show a dialog box during the Init( ) method.

If the current optimization stage is not supported, the model configuration does not match expectations, or the device is not available, then the Init( ) procedure is typically configured to return FALSE to abort the optimization.

Each plugin exports at least one function, SCO_PluginInit( ), declared as follows:

extern “C” _{——}declspec(dllexport) bool

SCO_PluginInit(void);

The SCO_PluginInit function is called by the SCOptimizer 100 to initialize the plugin. The plugin returns TRUE if the initialization is successful, and FALSE if the initialization is not successful. If FALSE is returned, then the plugin is unloaded and not used.

Each plugin can include at least one class, which is a child of the OptimizationPlugin class declared in the SCOptimizer 100 header file plugin.h. This class can include the actual fitness calculation code. It is possible to implement different fitness calculation algorithms in different OptimizationPlugin-derived classes and combine them in single “.sm” plugin module.

Child classes can implement the following functions and variables:

int Stages(void);

bool Init(DWORD param);

bool GetFitness(FloatArray &res, DWORD param);

void Close(void);

String_name;

The Stages(void) function returns a set of flags, which define which optimization stages are supported by the plugin. The following constants are defined in plugin.h:

| | |
|---|---|
| #define PLG_GA1 | 1 |
| #define PLG_GA2 | 2 |
| #define PLG_GA3 | 4 |
| #define PLG_BACKPROP | 8 |

The constant PLG_GA2 corresponds to GA-2 114 optimization, the constant PLG_GA3 corresponds to GA-3 optimization, the constant. PLG_GAL corresponds to GA-1 112 optimization, and the constant PLG_BACKPROP corresponds to Error Back Propagation.

The Init(DWORD param) function is called once before the beginning of the optimization process. The parameter param is a set of flags, which control the optimization. If the optimization includes several steps (such as, for example, sequential optimization of different outputs), then Init( ) is called before the first stage.

The plugin can return TRUE if it is ready for optimization and the selected mode is supported, otherwise, the plugin can return FALSE.

The GetFitness (FloatArray &res, DWORD param) function performs the fitness calculation. The parameter res is a reference to a FloatArray where the fitness vector is to be stored. The parameter param is a set of flags that define the optimization mode. The function returns TRUE if the fitness calculation is successful, and FALSE if an error occurs during fitness function calculation.

The function Close(void) is called after optimization is completed to allow the .plugin to free resources, close connections, etc.

The OptimizationPlugin class also defines the String member variable _name, which contains the name of the plugin (inside the class constructor). This name is displayed during plugin selection.

In order for a plugin to be known by the SCOptimizer plugin initialization function SCO_Plugin Init( ), the plugin can register all available OptimizationPlugin-derived classes using the RegisterOptimizationPlugin function as defined in plugin.h as:

BOOL RegisterOptimizationPlugin(OptimizationPlugin *op);

The user creates an instance of each OptimizationPlugin and passes a pointer to the object to register the function. The register function returns TRUE if the plugin is successfully added to the list of plugins, and FALSE on error.

To create a page inside the SCOptimizer 100 window, the user can call the SCController::AddPage( ) function, declared in SCController.h as:

bool SCController::AddPage(HWND hwnd, LPCTSTR title);

The hwnd parameter of the AddPage function is a window handle of the page to be added, title is a page title displayed in the tab control. The AddPage function returns TRUE if the page is successfully added to SCOptimizer 100 window, and FALSE on error.

In order to call this function the user can, however, have a pointer to the SCController object. A pointer to the SCController object can be obtained by the call to static function SCController::GetControl( ), declared in SCController.h as:

SCController *SCController::GetControl(void);

The SCController function returns a pointer to the SCController object, responsible for control of main window, or NULL in case of an error (window/controller not yet created).

The Plugin page receives a notification message when the model configuration is changed. Such notification messages are sent in the form of WM_UPDATE messages. A plugin can process the notification messages if desired.

Appendix A and Appendix B provide one example of an optimization plugin. Appendix A contains the header file for the sample plugin and Appendix B contains the C++ code of the sample plugin. The sample plugin is configured to be used with models having two inputs and one output. The sample plugin is configured to provide an approximate model of a function of two variables.

Although various embodiments have been described, other embodiments will be apparent to those of ordinary skill in the art. Thus, the present invention is limited only by the claims following the Appendices.

```
APPENDIX A
// Header file, TestPlugin.h
#include “SCOWin.h” //we will need it any way
#include “plugin.h” //for OptimizationPlugin declaration
extern HINSTANCE hPluginInstance; // our module instance
// initialization procedure
extern “C” _{——}declspec(dllexport) bool
SCO_PluginInit(void);
// dialog box message processing
BOOL CALLBACK TestDlgProc (HWND hwnd, UINT message,
WPARAM wParam, LPARAM lParam)
// optimization plugin object
class TestPlugin :
    public OptimizationPlugin
{
public:
    TestPlugin(void);
    ˜TestPlugin(void);
    // return supported stages (GA-2 114 & GA-3)
    int Stages(void);
    // Initialize optimization
    bool Init(DWORD param);
    // Return fitness value
    bool GetFitness(FloatVector &res,DWORD param);
    // Stops fitness calculations.
    void Close(void);
protected:
    // add variables, functions here as required
};
```

```
APPENDIX B
// source file for TestPlugin.cpp
#include “stdafx.h” // if the user use it
#include “TestPlugin.h” // our header file
#include “SCController.h”/* we want to add windows and
require SCController declaration */
#include “resource.h” // resource symbol file
//! Plugin dll module handle
HINSTANCE hPluginInstance;
//! DLL Initialization/deinitialization entry point
BOOL APIENTRY DllMain( HANDLE hModule,
                        DWORD ul_reason_for_call,
                        LPVOID lpReserved
                          )
{
    // store our handle
    hPluginInstance=(HINSTANCE)hModule;
    // process messages if required
    switch (ul_reason_for_call)
    {
    case DLL_PROCESS_ATTACH:
    case DLL_THREAD_ATTACH:
    case DLL_THREAD_DETACH:
    case DLL_PROCESS_DETACH:
        break;
    }
    return TRUE;
}
/* Plugin initialization procedure called by SCOptimizer
core after plugin is loaded
*/
_declspec(dllexport) bool SCO_PluginInit(void)
{
    String s;
    static TestPlugin plg;  // our plugin object
    // Get pointer to SCController.
    // Abort if it does not exist.
    SCController *control=SCController::GetControl( );
    if (!control)
        return FALSE;
    // Create page, which is modellless dialog box.
    // Parent of our page are SCOptmizer window
    // which handle is returned by control->hWnd( ).
    // Dialog messages are processed by TestDlgProc.
    HWND page;
    page=CreateDialog(hPluginInstance,MAKEINTRESOURCE(ID
    D_PAGE),
        control->hWnd( ),(DLGPROC)TestDlgProc);
    // Load page name from text resource
    s.LoadString(hPluginInstance,IDS_TITLE);
    control->AddPage(page,s);
    // register plugin
    if (!RegisterOptimizationPlugin(&plg)) return false;
    // all done, return true
    return true;
}
// dialog box message processing
BOOL CALLBACK TestDlgProc (HWND hwnd, UINT message,
WPARAM wParam, LPARAM lParam)
{
// Actual implementation of this function is out of the
scope
// of this example.
// However be sure it will never call EndDialog( ), for
example
// by response to ESC or ENTER key. This window are
destroyed
// together with SCOptimizer main window.
// This function can process WM_UPDATE (defined as
WM_USER+1 in scowin.h).
// Those messages are send by SCController when some
model parameters are
// changed.
}
// class constructor
TestPlugin::TestPlugin(void)
{
    // Load plugin name from text resource
    _name.LoadString(hPluginInstance,IDS_TITLE);
}
// Destructor
TestPlugin::˜TestPlugin(void)
{
}
// Return supported stages. We support GA-2 114 and GA-3
int TestPlugin::Stages(void)
{
    return PLG_GA-2 114|PLG_GA-3;
}
// Initialize fitness calculations
bool TestPlugin::Init(DWORD param)
{
    String s,s2;
    // First, we will check that inference engine is
available
    // and model configuration fits our requirements
    if(!Engine)
    {
        // Engine not loaded. We cann't get there
        // because this function is called only inside
        // engine object, but just in case...
        // Complain and return false.
        s.LoadString(hPluginInstance, IDS_NO_MODEL);
        s2.LoadString(hPluginInstance, IDS_TITLE);
        MessageBox(NULL,s,s2,MB_OK|MB_ICONSTOP);
        return false;
    }
    else
    if(Engine->GetInputVarCount( )!=2 || Engine-
>GetOutputVarCount( )!=1)
    {
        // This is more likely case - number of input
        // or output variables do not match our
expextations.
        // Complain and return false.
        s.LoadString(hPluginInstance,IDS_INCONSISTENT);
        s2.LoadString(hPluginInstance,IDS_TITLE);
        MessageBox(NULL,s,s2,MB_OK|MB_ICONSTOP);
        return false;
    }
    // Allocate resources, connect and initialize
hardware there,
    // read settings from window, etc..
    return true;
}
bool TestPlugin::GetFitness(FloatVector &res,DWORD param)
{
    float delta=0;
    int i;
    FloatVector in;// input vector for inference
    FloatVector out;  // output vector
    // set vector sizes
    in.SetSize(2);
    out.SetSize(1);
    // mark inputs as valid
    in.MarkAll(true);
    for(i=0;i<100;i++)
    {
        // set input variables
        in[0]=i;
        in[1]=100−i;
        // perform inference
    out=Engine->Infer(in);
        // Calculate difference between returned and
espected values.
        // out[0] is inference output
        // sin(i)*cos(100−i) is a sample function we
want to approximate
        // Since Genetic Algorithm tries to maximize
fitness value
        // we will use −fabs( ) as fitness. It will
reach maximum
        // value of 0 when inference output equals to
    our function.
        delta+=−fabs(out[0]−sin(i)*cos(100−i));
    }
    // normalize error
    delta/=(float)i;
    // set output vector size to 1
    res.SetSize(1);
    // SetAt( ) also marks element as valid, simple
    // res[0]=delta; will not work here, or can
    // be accomplished by res.Mark(0,true);
    res.SetAt(0,delta);
    return true;
}
// Stop fitness calculations.
void TestPlugin::Close(void)
{
// Free allocated resources here.
// We do not have resources to free.
}
```

What is claimed is:

1. An optimizer, comprising:
a first dialog configured to allow a user to specify one or more linguistic variable parameters;
a second dialog configured to allow the user to specify one or more membership function types;
a first genetic optimizer configured to optimize said linguistic variable parameters for a fuzzy model in a fuzzy inference system;
a first knowledge base trained by a use of a training signal;
a rule evaluator configured to rank rules in said first knowledge base according to firing strength and eliminating rules with a relatively low firing strength to create a second knowledge base; and
a second genetic analyzer configured to optimize said second knowledge base using said fuzzy model.

2. The soft computing optimizer of claim 1, further comprising an optimizer configured to optimize said fuzzy inference model using classical derivative-based optimization.

3. The soft computing optimizer of claim 1, further comprising a third genetic optimizer configured to optimize a structure of said linguistic variables using said second knowledge base.

4. The soft computing optimizer of claim 1, further comprising a third genetic optimizer configured to optimize a structure of membership functions in said fuzzy inference system.

5. The soft computing optimizer of claim 1, wherein said second genetic analyzer uses a fitness function based on measured plant responses.

6. The soft computing optimizer of claim 1, wherein said second genetic analyzer uses a fitness function based on modeled plant responses.

7. The soft computing optimizer of claim 14, wherein said second genetic analyzer uses a fitness function configured to reduce entropy production of a controlled plant.

8. The soft computing optimizer of claim 1, wherein said first genetic algorithm is configured to choose a number of membership functions for said first knowledge base.

9. The soft computing optimizer of claim 1, wherein said first genetic algorithm is configured to choose a type of membership functions for said first knowledge base.

10. The soft computing optimizer of claim 1, wherein said first genetic algorithm is configured to choose parameters of membership functions for said first knowledge base.

11. The soft computing optimizer of claim 1, wherein a fitness function used in said second genetic algorithm depends, at least in part, on a type of membership functions in said fuzzy inference system.

12. The soft computing optimizer of claim 1, further comprising a third genetic analyzer configured to optimize said second knowledge base according to a search space from the parameters of said linguistic variables.

13. The soft computing optimizer of claim 1, further comprising a third genetic analyzer configured to optimize said second knowledge base by minimizing a fuzzy inference error.

14. The soft computing optimizer of claim 1, wherein said second genetic optimizer uses an information-based fitness function.

15. The soft computing optimizer of claim 1, wherein said first genetic optimizer uses a first fitness function and said second genetic optimizer uses said first fitness function.

18. The soft computing optimizer of claim 14, wherein said second genetic optimizer uses a fitness function configured to optimize based on user preferences.

19. The soft computing optimizer of claim 1, wherein said second genetic optimizer uses a nonlinear model of a controlled plant.

20. The soft computing optimizer of claim 1, wherein said second genetic optimizer uses a nonlinear model of an unstable plant.

21. The soft computing optimizer of claim 1, wherein said training signal is obtained from an optimal control signal.

22. The soft computing optimizer of claim 1, wherein said optimal control signal is computed using a plugin module.
